(19) United States
(12) Patent Application Publication
(10) Pub. No.: US 2025/0253884 A1
(43) Pub. Date: Aug. 7, 2025

(54) BIDIRECTIONAL COMMUNICATION FOR FRONT END MODULE (FEM)

(71) Applicant: Qorvo US, Inc., Greensboro, NC (US)

(72) Inventors: George Maxim, Saratoga, CA (US); Suryanarayana Pappu, Gilbert, AZ (US); Paul Bricketto, High Point, NC (US); Jackie Johnson, Trinity, NC (US); Woo Yong Lee, Chapel Hill, NC (US); Nadim Khlat, Cugnaux (FR); Baker Scott, San Jose, CA (US)

(21) Appl. No.: 18/855,023

(22) PCT Filed: May 19, 2023
(86) PCT No.: PCT/US2023/022823

§ 371 Date: Oct. 8, 2024

Related U.S. Application Data
(60) Provisional application No. 63/347,639, filed on Jun. 1, 2022.
(60) Provisional application No. 63/379,514, filed on Oct. 14, 2022.

(51) Int. Cl. H04B 1/401

(52) U.S. Cl. CPC H04B 1/401

(57) ABSTRACT

Systems and method for bidirectional communication for front end modules (FEM) are disclosed. In one aspect, a bidirectional communication path tunneling through an existing communication bus between a FEM and a baseband processor is created. In a particular aspect, a driver may be hosted by an external processor and communicate with the baseband processor to effectuate the desired tunneled communication through the bus between the baseband processor and the FEM. The bidirectional communication may allow the FEM to adjust settings to optimize performance based on the information provided by the baseband processor. Likewise, information from the FEM may be used to adjust operation of the baseband processor.

### PRIORITY APPLICATIONS

The present application is related to U.S. Provisional Patent Application Ser. No. 63/379,514 filed on Oct. 14, 2022, and entitled “BIDIRECTIONAL COMMUNICATION FOR FRONT END MODULE (FEM),” the contents of which are incorporated herein by reference in its entirety.

The present application is related to U.S. Provisional Patent Application Ser. No. 63/347,639 filed on Jun. 1, 2022, and entitled “SMARTPATH WITH SMART FEM FOR DYNAMIC AND ADAPTIVE OPTIMIZATION OF TX AND RX PATH IN MOBILE FRONT ENDS,” the contents of which are incorporated herein by reference in its entirety.

### BACKGROUND

### I. Field of the Disclosure

The technology of the disclosure relates generally to front end modules (FEMs) in mobile devices and particularly to communication between a baseband module and a FEM in a mobile device.

### II. Background

Computing devices abound in modern society, and more particularly, mobile communication devices have become increasingly common. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences. With the advent of the myriad functions available to such devices, there has been increased pressure to provide more bandwidth to handle increased data loads used by the myriad functions. This pressure has resulted in evolutions in wireless standards. One typical approach to handle more bandwidth is through the use of higher frequencies. With each frequency evolution, increased pressure is put on front end modules within the mobile communication device to comply with the new wireless standard. Such pressure provides room for innovation.

### SUMMARY

Aspects disclosed in the detailed description include systems and methods for bidirectional communication for front end modules (FEMs). In particular, exemplary aspects of the present disclosure contemplate a bidirectional communication path tunneling through an existing communication bus between a FEM and a baseband processor (BBP). In a particular aspect, a driver, which may be locally hosted or may be hosted by an external processor, communicates with circuitry within the BBP to effectuate the desired tunneled communication through the bus between the BBP and the FEM. The bidirectional communication may allow the FEM to adjust settings to optimize performance based on the information provided by the BBP. Likewise, information from the FEM may be used to adjust operation of the BBP.

In this regard in one aspect, a BBP is disclosed. The BBP comprises a bus interface. The bus interface is configured to couple to a FEM through a bus. The bus interface is also configured to communicate to the FEM using a first protocol. The BBP also comprises a control circuit configured to interoperate with a driver that communicates bidirectionally with the FEM by tunneling through the first protocol.

In another aspect, a method of controlling a FEM in a mobile device is disclosed. The method comprises reading information from a register in the FEM using an encapsulated command. The method also comprises passing the information from the register to a driver. The method also comprises, based on the information, sending a command to the FEM using a second encapsulated command.

In another aspect, a mobile device is disclosed. The mobile device comprises a FEM. The mobile device also comprises a communication bus coupled to the FEM. The mobile device also comprises a BBP coupled to the communication bus and configured to communicate bidirectionally with the FEM using encapsulated read and write commands.

### BRIEF DESCRIPTION OF THE DRAWINGS

FIG. 1 is a block diagram of an exemplary mobile device having a baseband processor (BBP) and a front end module (FEM) with bidirectional communication therebetween;

FIG. 2 is a block diagram of an exemplary mobile device having a BBP and a FEM with tunneled bidirectional communication therebetween effectuated by a driver in an external processor;

FIG. 3 is a block diagram of an exemplary mobile device having multiple BBPs and FEMs with tunneled bidirectional communication therebetween effectuated by a driver in an external processor;

FIG. 4A is a block diagram of an exemplary mobile device having a driver to effectuate bidirectional communication with not just the BBP and FEM, but also with other elements within a transceiver architecture;

FIG. 4B is a block diagram of an exemplary mobile device having a driver in an external processor to effectuate bidirectional communication with not just the BBP and FEM, but also with other elements within a transceiver architecture;

FIG. 5 is a block diagram of the mobile device of FIG. 1 with additional details about the information provided from the BBP to the driver and adjustments that may be made in the FEM by the driver using exemplary aspects of the bidirectional communication of the present disclosure;

FIG. 6 is a block diagram of the mobile device of FIG. 1 with additional details about the driver and the host of the driver;

FIG. 7 is a block diagram of the mobile device of FIG. 1 with additional detectors in the FEM to assist the driver in determining operating conditions;

FIG. 8 is a block diagram of the mobile device of FIG. 1 with additional details about how key performance indicators (KPI) may be used to assist the driver in determining operating conditions; and

FIG. 9 is a block diagram of the mobile device of FIG. 1 with additional details about how a machine learning module may be used to assist in determining dynamic control of the BBP and FEM based on operating conditions.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description include systems and methods for bidirectional communication for front end modules (FEM). In particular, exemplary aspects of the present disclosure contemplate a bidirectional communication path tunneling through an existing communication bus between a FEM and a baseband processor (BBP). In a particular aspect, a driver, which may be locally hosted or may be hosted by an external processor, communicates with circuitry within the BBP to effectuate the desired tunneled communication through the bus between the BBP and the FEM. The bidirectional communication may allow the FEM to adjust settings to optimize performance based on the information provided by the BBP. Likewise, information from the FEM may be used to adjust operation of the BBP.

In the past, the amount of information passed between the BBP and the FEM was generally limited to a unidirectional communication bus such as the Radio Frequency Front End (RFFE) bus promulgated by MIPI (version 3 published April 2020, available to MIPI members). Further, the type of information sent from the BBP to the FEM was frequently limited, and the FEM operated in a generally static mode without dynamic variations based on conditions known to the FEM and/or with limited changes based on operational modes as instructed by the BBP.

Exemplary aspects of the present disclosure allow for a driver to write operational parameters to and read operating condition information from registers in the FEM through an existing communication bus through a tunneling process. As used herein, “tunneling” is a technique for transferring data securely from one device to another. More specifically, tunneling contemplates “encapsulating” data and commands that are outside the scope of a particular communication protocol within packets formatted according to the protocol. The bus and the bus interfaces for the devices only “see” properly formatted packets or signals. At the destination, the packet is unpacked and the encapsulated data or command is then read and used. In this fashion, the packets appear to be general packets accepted within the protocol allowing them to pass unnoticed until unpacking when the device may act on the commands or data therewithin. In a particularly contemplated aspect, the tunneling is done using an RFFE compliant bus, and the commands and/or data are encapsulated within RFFE packets. While RFFE is specifically contemplated, buses compliant with other protocols may also benefit from the present disclosure.

Information related to the operating conditions at the FEM may be shared with the BBP so that the BBP may adjust operation (of the BBP or the FEM) as needed to compensate. This ability allows for more dynamic control of the FEM which, in turn, provides better (e.g., more efficient or more readily compliant with a wireless standard) performance for the mobile device. Exemplary information provided by the FEM may include, but are not limited to, frequency blockers, temperature, sensed Vcc levels, voltage to standing wave ratio (VSWR), power level protection status, or the like.

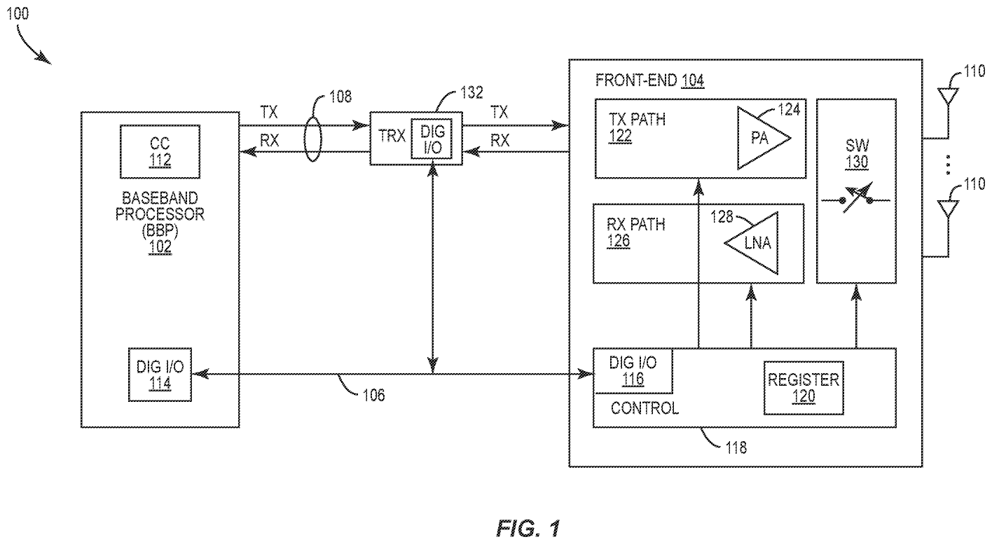

To provide context for exemplary aspects of the present disclosure, FIG. 1 is a block diagram of a mobile device 100 having a BBP 102 that communicates bidirectionally with an FEM 104 through a communication bus 106 such as an RFFE bus. Additionally, signals for transmission may be passed through a signal bus 108 from the BBP 102 to the FEM 104 for wireless transmission through an antenna 110. Likewise, signals received at the antenna 110 may pass through the signal bus 108 to the BBP 102. The present disclosure is not interested in these transmitted and received signals and generally such signals are not carried on an RFFE bus (e.g., bus 106). The BBP 102 may include a control circuit 112 and a digital input/output (I/O) physical interface 114 (also sometimes referred to as a bus interface or a PHY).

The FEM 104 may include a digital I/O physical interface 116 (also sometimes referred to as a bus interface or a PHY) and control circuit 118 with associated registers 120. The FEM 104 may include a transmission path 122 with associated power amplifier 124 and a receive path 126 with associated low noise amplifier (LNA) 128. The FEM 104 may switch between use of the transmission path 122 and the receive path 126 using a switching circuit 130 that couples one or the other paths 122, 126 to the antenna 110. Note that multiple antennas 110 may be used to support diversity reception/transmission and/or multiple in/multiple out (MIMO) techniques including beam steering or the like. The control circuit 118 may control aspects of the operation of the transmission path 122 and receive path 126 as well as the switching circuit 130 based on information stored in the registers 120 (as better explained in greater detail below). It is possible that the BBP 102 includes intermediate frequency processing circuitry (not shown), or there may be an I/F circuit 132 positioned between the BBP 102 and the FEM 104 that upconverts/downconverts signals passing through the antennas 110 as is well understood. The I/F circuit 132 may also communicate to other circuits using the bus 106.

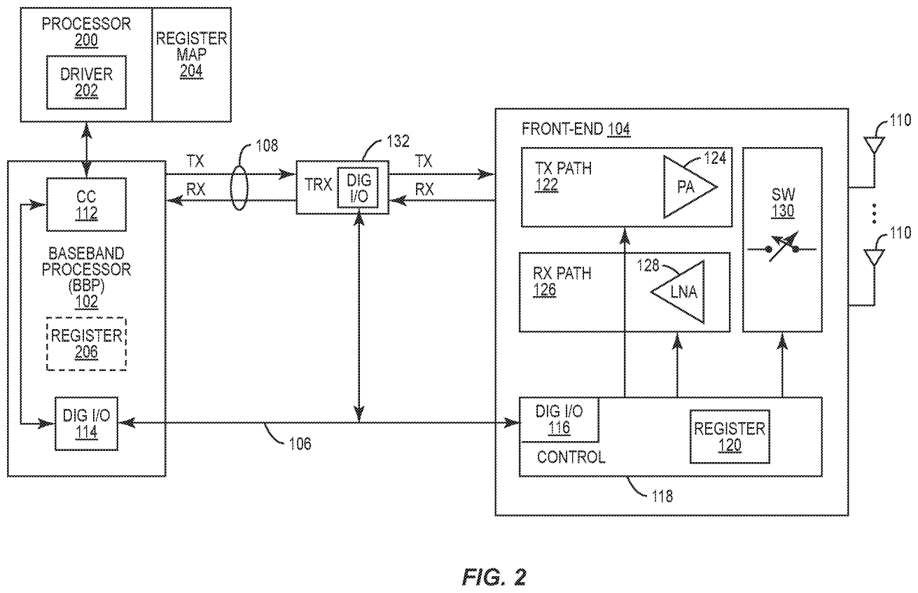

Exemplary aspects of the present disclosure contemplate a driver 202 that may be hosted in the BBP 102 (not shown), some other portion of a modem circuit that includes the BBP 102 (also not shown), or hosted in an external circuit such as a processor 200 (illustrated in FIG. 2). The processor 200 may further include memory that includes a register map 204 which provides a map of registers 120 and registers 206 within the BBP 102. The driver 202 is responsible for instructing the BBP 102 to encapsulate signals (e.g., instructions, commands (read and/or write), and/or data) for transmission to the FEM 104 by tunneling across the bus 106. Likewise, the driver 202 is responsible for reading information sent from the FEM 104 as well as evaluating operating parameters provided to the driver 202 by the BBP 102. Based on the information received at the driver 202, the driver 202 may cause operation of the BBP 102 and/or FEM 104 to change so as to provide dynamic optimization of operation.

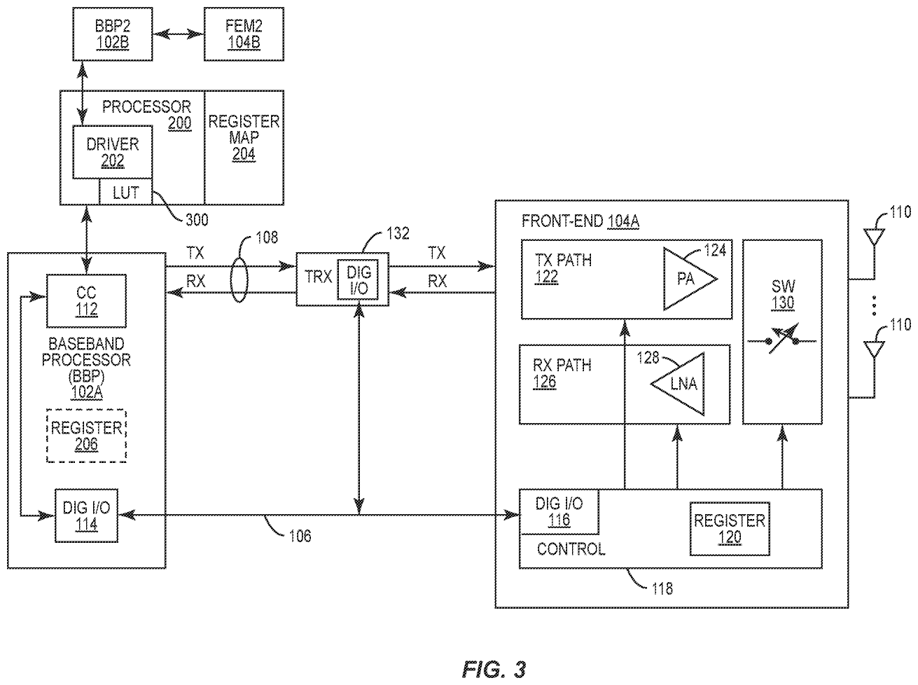

Exemplary aspects of the present disclosure also contemplate that the driver 202 (regardless of position) may operate with multiple BBPs and FEMs as better illustrated in FIG. 3. Specifically, the driver 202 in the processor 200 may operate with BBPs 102A, 102B (and more not shown). The BBP 102A may have an associated FEM 104A, and the BBP 102B may have an associated FEM 104B. In all other respects, the BBPs 102A, 102B may be identical to the BBP 102 previously described. Likewise, the FEMs 104A, 104B may be identical to the FEM 104 previously described. An additional look-up table (LUT) 300 may be present in the processor 200 to assist in mapping signals to and from the appropriate BBP 102A, 102B and FEM 104A, 104B.

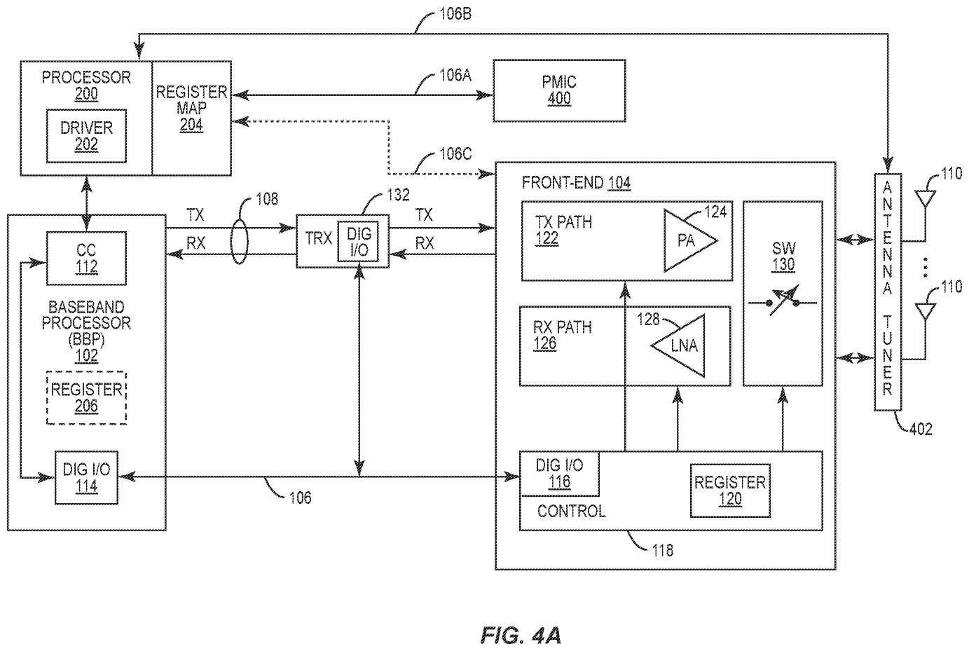

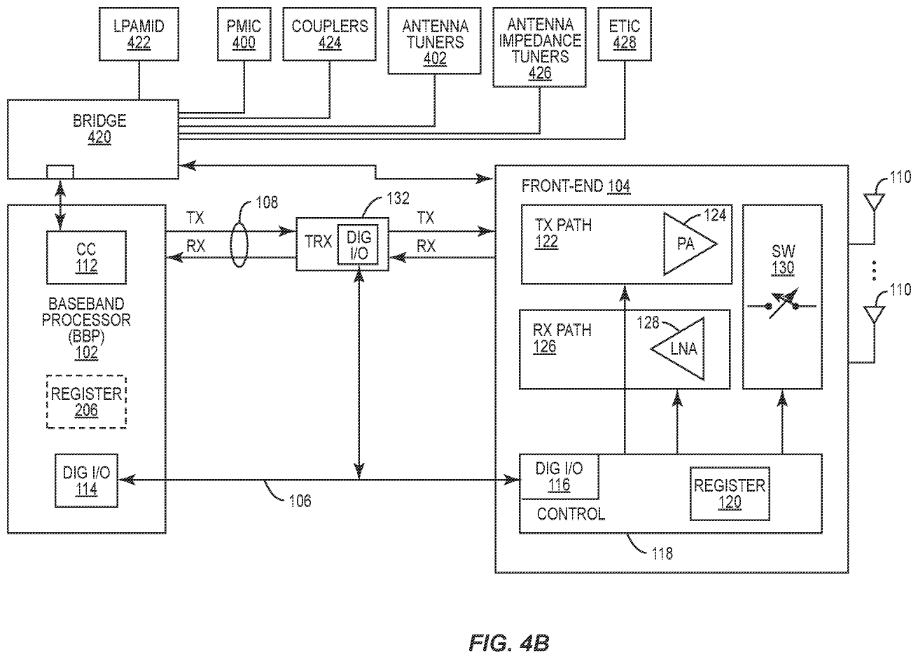

While it is contemplated that most communication may be effectuated between the driver 202 and the BBP 102 using the connections of the BBP 102 to the FEM 104, exemplary aspects of the present disclosure are not so limited. As better illustrated in FIG. 4A, the driver 202 may be able to communicate directly to other elements of the transceiver architecture such as a power management integrated circuit (PMIC) 400 and/or an antenna tuner circuit 402 through alternate buses 106A, 106B. The protocol used over the alternate buses 106A, 106B may still be a protocol such as RFFE and tunneling may be used as needed. Note that direct communication without the need for tunneling is also contemplated and, for example, a non-RFFE direct bus 106C between the driver 202 and the FEM 104 may exist. Note also that the buses 106A, 106B, 106C may also be a single RFFE bus that the driver 202 has direct access to (i.e., without the need to go through the BBP 102).

The aspect shown in FIG. 4A contemplates the driver 202 in the modem containing the BBP 102 or within another processor 200 such as the application processor. However, another option, illustrated in FIG. 4B is a dedicated integrated circuit (IC) or bridge 420 which may act as a master on a bus such as an RFFE bus and use tunneling or have a direct bus that does not need tunneling. For example, the bridge 420 may be coupled the BBP 102, the FEM 104, as well as a LNA and power amplifier with integrated diplexer (LPAMID) 422, a PMIC 400, one or more couplers 424, antenna tuner circuits 402, antenna impedance tuners 426, and/or an envelope tracking integrated circuit (ETIC) 428 (or an average power tracking circuit (APT) (not shown)). Registers (not shown) may be used to provide access to information about operating conditions and/or instructions to modify performance of any of these elements. Still other elements may be added to this direct communication if needed or desired. Note also, that the bridge 420 may include a driver such as the driver 202 or may implement all functions through hardware without any software overlay.

With the various hardware layouts possible are shown in FIGS. 1-4B, the present discussion turns to the type of information that may be exchanged. It should be appreciated that in most cases the information from the remote elements (e.g., the FEM 104) will be “pulled” or read from the registers in the remote elements rather than the remote element proactively sending information to the driver 202. However, exemplary aspects of the present disclosure include both formats.

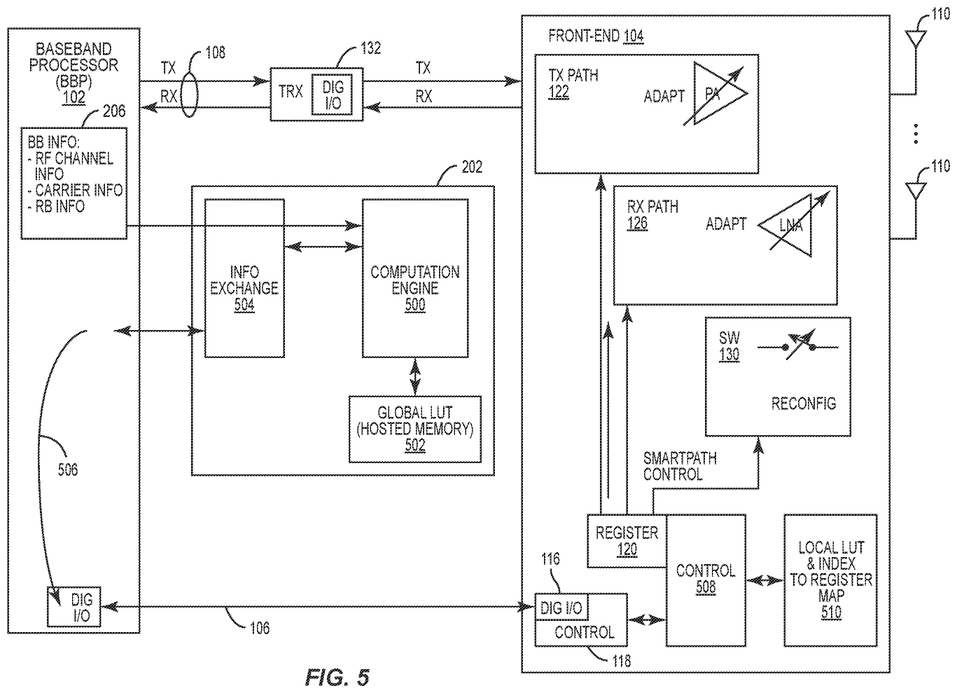

FIG. 5 provides a block diagram of the mobile device of FIG. 1 with additional details about the information provided from the BBP 102 to the driver 202 in the processor 200 (or other location, not explicitly shown in FIG. 5) and adjustments that may be made in the FEM 104 by the driver 202 using exemplary aspects of the bidirectional communication of the present disclosure. In particular, the BBP 102 may store information such as RF channel information, sub-band information, bandwidth information, carrier aggregation or other carrier information, resource block information, peak to average ratio (PA), maximum power reduction (MPR), ENDC mode, and the like. This information may be provided to the driver 202. The driver 202 may use a computation engine 500 assisted by a global LUT 502 (which may include the LUT 300 and register map 204) to determine what information to send to the FEM 104. Likewise, the driver 202 may include an information exchange module 504 to handle sending and receiving information from the FEM 104 (e.g., register control signals 506). Within the FEM 104, the information in the registers 120 may be accessed by the control circuit 118 and/or a separate control compute unit 508 to change settings in the transmit path 122, the receive path 126, and/or the switching circuit 130. Additionally, the control circuit 118 and/or the control compute unit 508 may work with a local LUT 510 that provides an index for the registers 120.

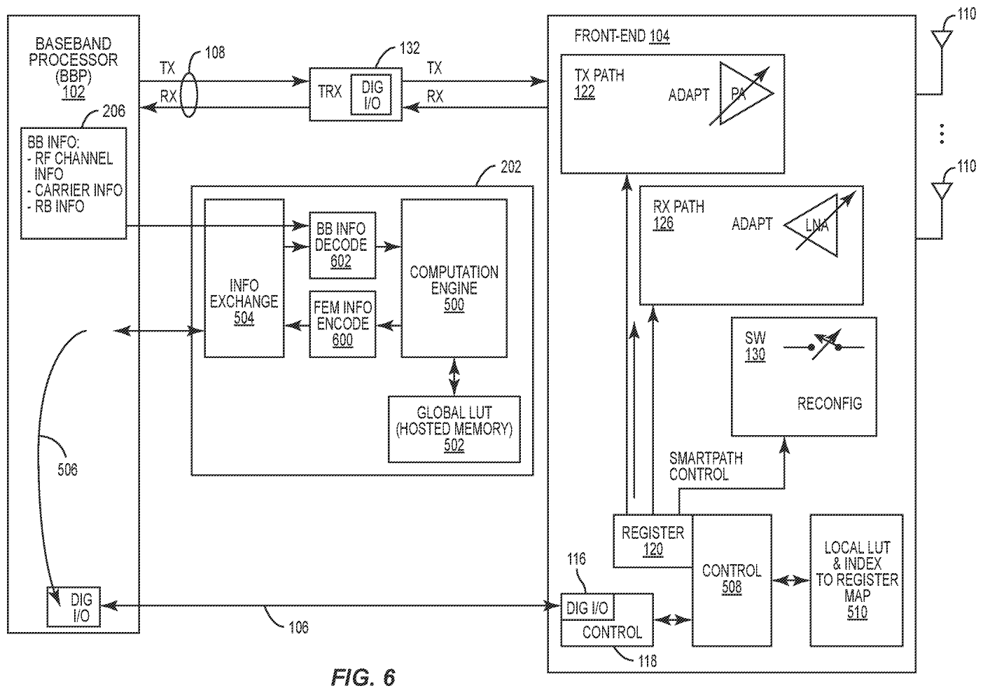

Note that the driver 202 may include an encoding block 600 and a decoding block 602 as better seen in FIG. 6. The encoding block 600 may assist in encapsulating information from the computation engine 500 so that the information may tunnel across the bus 106. Likewise, decoding blocks 602 may extract encapsulated information that has tunneled across the bus 106 to be considered by the computation engine 500. Similarly, the control compute unit 508 may encode and decode data being sent from and to (respectively) the FEM 104.

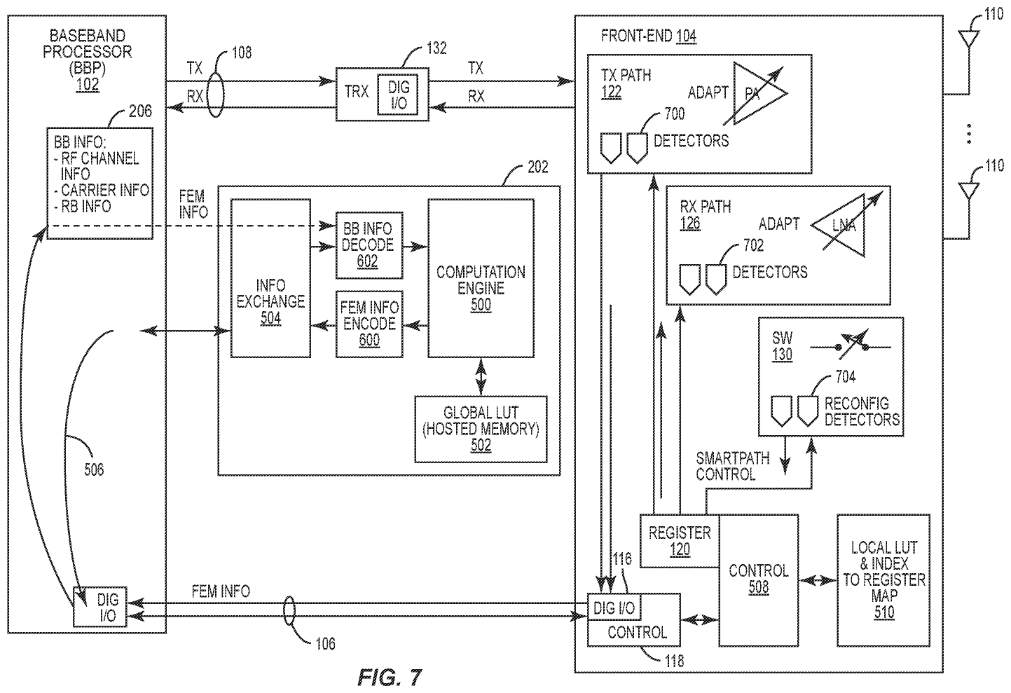

To assist in providing information to the driver 202, the FEM 104 may be equipped with one or more sensors or detectors which are configured to determine operating conditions and report to the control circuit 118 or the control compute unit 508 for encoding and transmission to the driver 202 as better illustrated in FIG. 7. By way of example, but not necessarily limiting, a detector 700 may be associated with the transmit path 122, a detector 702 may be associated with the receive path 126, and a detector 704 may be associated with the switching circuit 130. The detectors 700, 702, and 704 may detect temperature, supply voltages, blockers, power protection status, or the like. Note that while referenced as a singular detector 700, 702, 704, the detectors 700, 702, 704 may include multiple detectors in each location designed to detect different operating conditions.

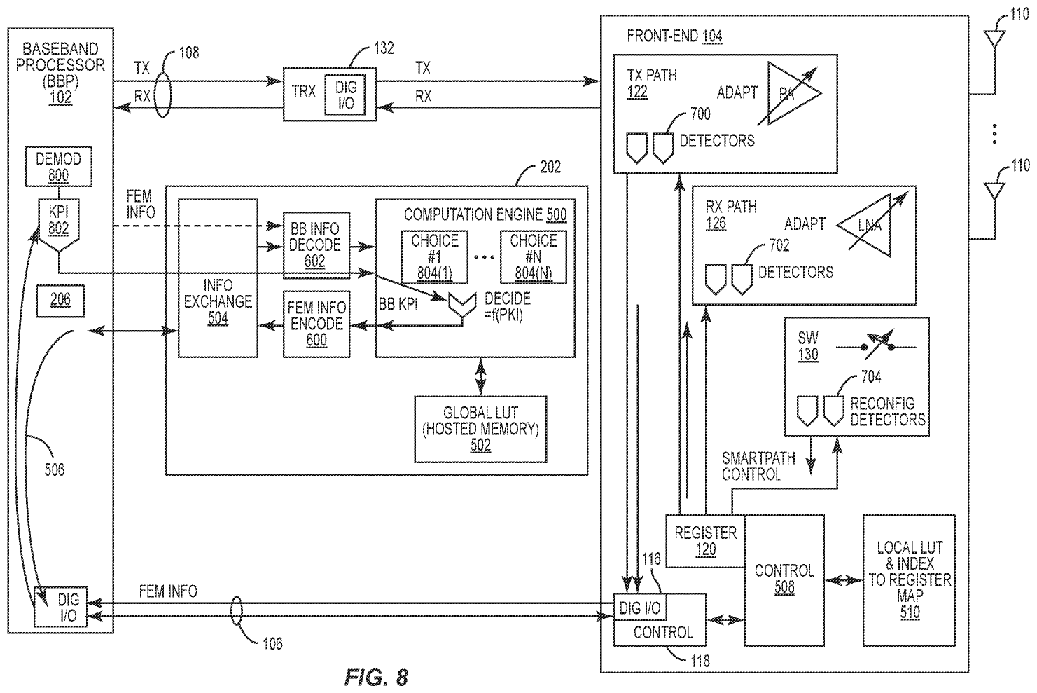

It should be appreciated that while having information from the FEM 104 to inform operational adjustments provides substantial improvements in performance, the present disclosure is not so limited. Additional information may be provided by the BBP 102 to the driver 202 as better illustrated in FIG. 8. Specifically, the BBP 102 may have some ability to demodulate information with a demodulator 800 to determine one or more key performance indicators (KPIs) 802, which are provided to the computation engine 500. In an exemplary aspect, information about the KPI is provided (i.e., KPI information) which may be the actual KPI or an indication that the KPI is above (or below) a threshold. Exemplary KPIs include bit error rate (BER), signal to noise ratio (SNR), error vector magnitude (EVM), signal to noise distortion ratio (SNDR), or the like. Based on the KPI (e.g., f(KPI)), the computation engine 500 may select between a variety of preconfigured choices 804(1)-804(N) and provide instructions to the FEM 104 based on the selected choice.

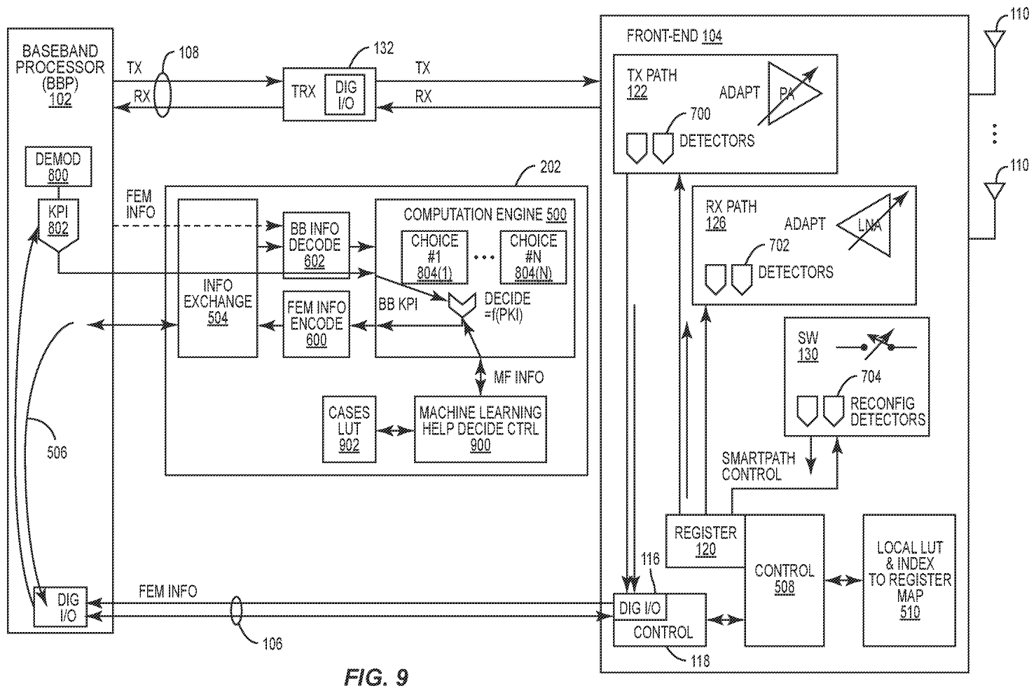

Note also that the computation engine 500 may benefit from a machine learning process so that optimizations are improved through experiential learning. One such aspect is illustrated in FIG. 9, where the driver 202 has a machine learning module 900 that works with a cases LUT 902 to improve adjustments made to the FEM 104 based on the detected operating conditions.

While the above discussion assumes that there may be a single optimization scheme or set of optimization instructions based on operating conditions, this assumption may not always be true. For example, one set of adjustments may be optimal for transmission while another set of adjustments may be optimal for reception. The driver 202 (or bridge 420) may be programmed to select a more desired set of adjustments or find a compromise set of adjustments which provides the best optimization for both modes without being the best for either mode individually.

To the extent it was not explicitly stated above, any of the aspects of FIGS. 5-9 may be applied to the structures of FIGS. 1-4B. Likewise, while the present discussion has presented the driver 202 as a monolithic entity hosted in a single location, exemplary aspects of the present disclosure include the possibility that the driver 202 may be split amongst multiple processors (e.g., part in the modem processor and part in an application processor).

It should further be appreciated that the systems described above also disclose methods for controlling a front end module by virtue of the FEM providing information to the driver and the driver issuing commands to the FEM to change operation. It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

1. A baseband processor (BBP), comprising:
a bus interface configured to:
couple to a front end module (FEM) through a bus; and
communicate to the FEM using a first protocol; and
a control circuit configured to interoperate with a driver that communicates bidirectionally with the FEM by tunneling through the first protocol, wherein tunneling comprises encapsulating data and commands that are outside a scope of the first protocol within packets formed according to the first protocol and the driver is configured to instruct the control circuit to encapsulate the data and commands for transmission through the bus interface.

2. The BBP of claim 1, wherein the control circuit is further configured to read information from a register in the FEM by tunneling.

3. The BBP of claim 1, wherein the control circuit is configured to interoperate with the driver by communicating with a remote application processor.

4. The BBP of claim 1, wherein the control circuit is configured to interoperate with the driver at a local modem processor.

5. The BBP of claim 1, wherein the control circuit is further configured to receive encapsulated instructions for the FEM.

6. The BBP of claim 1, wherein the control circuit is configured to interoperate with the driver at a bridge.

7. The BBP of claim 2, wherein the control circuit is further configured to read detector information in the register.

8. The BBP of claim 2, wherein the control circuit is further configured to read operating condition information in the register.

9. The BBP of claim 1, wherein the control circuit is further configured to send information about the BBP to the driver.

10. The BBP of claim 9, wherein the control circuit is configured to send key performance indicator (KPI) information to the driver.

11. The BBP of claim 9, wherein the control circuit is configured to send operating condition information to the driver.

12. A method of controlling a front end module (FEM) in a mobile device, the method comprising:
reading information from a register in the FEM using a command outside a scope of a first protocol, wherein the command is encapsulated within a signal formatted according to the first protocol;
passing the information from the register to a driver; and
based on the information, sending a command to the FEM using a second command outside the scope of the first protocol, wherein the second command is encapsulated within a second signal formatted according to the first protocol.

13. The method of claim 12, wherein the command adjusts an operating parameter of an element within the FEM.

14. The method of claim 12, further comprising hosting the driver in a modem processor.

15. The method of claim 12, further comprising hosting the driver in an application processor.

16. A mobile device comprising:
a front end module (FEM);
a communication bus coupled to the FEM; and
a baseband processor (BBP) coupled to the communication bus and configured to communicate bidirectionally with the FEM using tunneled read and write commands;
wherein tunneled commands comprise encapsulated commands that are outside a scope of a first protocol within packets formed according to the first protocol.

17. The mobile device of claim 16, further comprising a driver hosted in a modem processor associated with the BBP.

18. The mobile device of claim 16, wherein the FEM comprises at least one detector associated with an element of the FEM, and a register, wherein information from the at least one detector is stored in the register and the BBP is configured to read the register using an encapsulated read command.

19. The mobile device of claim 16, further comprising a power management integrated circuit (PMIC) and wherein the BBP is configured to control the PMIC based on information from the FEM.

20. The mobile device of claim 16, wherein the BBP is configured to provide information to a driver and receive the encapsulated read and write commands from the driver.
